(19) United States
(12) Patent Application Publication
(10) Pub. No.: US 2007/0293618 A1
(43) Pub. Date: Dec. 20, 2007

(54) CURABLE POWDER FILM-FORMING COMPOSITION EXHIBITING IMPROVED FLOW AND LEVELING

(75) Inventors: Karen A. Barkac, North Huntingdon, PA (US); Deirdre D. Ragan, Pittsburgh, PA (US); Karen S. Rechenberg, Gibsonia, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/846,771

(22) Filed: Aug. 29, 2007

Related U.S. Application Data
(63) Continuation of application No. 10/360,263, filed on Feb. 6, 2003, now abandoned.
(60) Provisional application No. 60/358,281, filed on Feb. 20, 2002.

(51) Int. Cl. C08K 3/18; C08K 3/34

(52) U.S. Cl. 524/430

(57) ABSTRACT

A curable powder film-forming composition is provided, comprising (i) 5 to 95 percent by weight of a crosslinking agent; (ii) 5 to 95 percent by weight of a polymer containing a plurality of functional groups reactive with the crosslinking agent; and (iii) particles having a mean particle size less than 100 nm. The particles comprise 10 to 70 percent by weight aluminum oxide and 30 to 90 percent by weight silica, and are substantially free of functional groups on the particle surface. The particles are present in an amount sufficient to improve the flow and leveling of the composition when applied to a substrate and cured, compared to a similar cured coating without the particles. A multi-component composite coating composition is also provided, comprising a pigmented basecoat and a clear coat. The basecoat and/or clearcoat may be derived from the curable film-forming composition described above.

### CROSS-REFERENCE TO RELATED APPLICATION

This application is a continuation of U.S. patent application Ser. No. 10/360,263, filed Feb. 6, 2003, which in turn claims priority under 35 U.S.C. § 119 to Provisional Application Ser. No. 60/358,281, filed Feb. 20, 2002.

### FIELD OF THE INVENTION

The present invention relates to particulate (powder) curable film-forming compositions containing flow control agents.

### BACKGROUND OF THE INVENTION

Coating compositions, e.g., liquid and powder coating compositions, are used in a wide variety of applications, including, for example, the automotive, appliance and industrial markets. Coatings are often used to provide decorative qualities and/or corrosion protection to the substrates over which they are applied. Correspondingly, applied coatings are typically required to have at least a continuous defect-free surface, and in the case of decorative finishes, also a very smooth surface. The automotive industry has particularly strict requirements as to the smoothness of the coatings that are used, as is the case with automotive clear topcoat compositions.

Coating compositions typically contain a flow control agent (also referred to as a flow modifier) to improve the appearance of the cured coating. Flow control agents have surface active properties and are thought to improve the appearance of a cured coating by altering the flow and leveling of the applied coating during its cure cycle. Flow control agents containing functional groups, e.g., carboxylic acid groups and/or hydroxyl groups, are known, and in addition to enhancing appearance, can also improve the adhesion of the coating to the substrate over which it is applied, and/or improve the adhesion or compatibility of a subsequently applied coating.

Coating compositions are typically required to provide optimum properties, e.g., appearance and/or corrosion resistance, at a minimum film thickness. For example, in the automotive industry, clear topcoats are typically required to have cured film thicknesses of no greater than 75 microns (2 3.0 mils). Advantages associated with coatings applied at lower film thickness include, for example, reduced material costs and weight gain of the coated ware, which is particularly desirable in the aircraft industry. However, as the film build of an applied coating composition is decreased, the appearance of the resulting cured coating typically diminishes, for example, by lower measured appearance values.

In addition to the application of coatings at lower film builds, research and development in recent years has been directed towards reducing the environmental impact of coatings compositions, in particular that associated with emissions into the air of volatile organic materials during their use. Accordingly, interest in coatings having lower volatile organic content (VOC), e.g., powder coatings and high solids coatings, has been increasing. Powder coating compositions are free flowing particulate compositions that are substantially free of solvents. The appearance of powder coatings typically degrades rather precipitously with decreasing film thickness, e.g., at film thicknesses less than 75 microns (3 mils), and in particular at film thicknesses less than 50 microns (2 mils). In the absence of solvents that can enhance the flow and leveling of an applied coating, a flow control agent is a critical component in the majority of powder coating compositions.

It would be desirable to develop coating compositions, in particular, powder coating compositions that have improved properties such as appearance. In particular, it would be desirable to develop coating compositions that have improved properties, such as appearance, at lower film thicknesses, e.g., film thicknesses less than or equal to 50 microns.

U.S. Pat. No. 5,212,245 describes thermosetting powder coating compositions comprising a curable particulate resinous material and a flow control agent. The flow control agent is a copolymer of an alkyl acrylate and/or alkyl methacrylate containing from 6 to 20 carbon atoms in the alkyl group, and a hydroxyalkyl acrylate and/or hydroxyalkyl methacrylate.

International Patent Publication No. WO 97/30131 describes curable coating compositions comprising either a liquid or particulate curable film-forming resinous material and a flow control agent. The flow control agent of Publication No. WO 97/30131 is described as being a copolymer of at least one alkyl acrylate and/or alkyl methacrylate containing from 1 to 20 carbon atoms in the alkyl group, an amino functional acrylate and/or amino functional methacrylate, and optionally a hydroxyalkyl acrylate and/or hydroxyalkyl methacrylate.

### SUMMARY OF THE INVENTION

In accordance with the present invention, a curable power film-forming composition is provided, comprising (i) 5 to 95 percent by weight based on the total weight of the film-forming composition of a crosslinking agent; (ii) 5 to 95 percent by weight based on the total weight of the film-forming composition of a polymer containing a plurality of functional groups reactive with the crosslinking agent; and (iii) particles having a mean particle size less than 100 nm. The particles comprise 10 to 70 percent by weight, based on the total weight of the particles, aluminum oxide and 30 to 90 percent by weight, based on the total weight of the particles, silica, and are substantially free of hydroxyl functional groups of the particle surface. The particles are present in an amount at least sufficient to improve the flow and leveling of the composition when applied to a substrate and cured, as measured by longwave scanning, compared to a similar cured coating without the particles.

A multi-component composite coating composition is also provided. The coating composition comprises a pigmented film-forming composition serving as a base coat and a clear film-forming composition serving as a transparent topcoat over the base coat. The transparent topcoat, or clear coat, is derived from the curable powder film-forming composition described above. The compositions of the present invention exhibit improved flow and leveling properties upon application to a substrate, resulting in excellent appearance properties in the cured film, particularly when compared to compositions that do not contain the particles.

Also provided are coated substrates in which the curable coating compositions or the multi-component composite coating compositions described above are applied to a substrate and cured to form a cured coating; the cured coating having a thickness of less than 75 microns. In the case of the multi-component composite coating composition, the clear coat has thickness of less than 75 microns.

### DETAILED DESCRIPTION

Other than in any operating examples, or where otherwise indicated, all numbers expressing quantities of ingredients, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The crosslinking agent (i) typically is present in the curable powder film-forming composition of the present invention in an amount ranging from at least 5 percent by weight, preferably at least 20 percent by weight based on the total weight of resin solids in the curable powder film-forming composition. The crosslinking agent (i) also typically is present in the curable powder film-forming composition of the present invention in an amount less than 95 percent by weight, preferably less than 80 percent by weight, based on the total weight of resin solids in the film-forming composition. The amount of the crosslinking agent (i) present in the film-forming composition of the present invention is dependent on the type of crosslinking agent used, and can range between any combination of the above values inclusive of the recited values. Examples of suitable crosslinking agents include any known crosslinking agents useful in powder curable film-forming compositions.

Epoxide reactive crosslinking agents that are useful in the film-forming compositions of the present invention may have functional groups selected from hydroxyl, thiol, primary amines, secondary amines, carboxyl and mixtures thereof. Useful epoxide reactive crosslinking agents having amine functionality include, for example, dicyandiamide and substituted dicyandiamides. Preferably, the epoxide reactive crosslinking agent has carboxylic acid groups. In one embodiment of the present invention, the epoxide reactive crosslinking agent has carboxylic acid functionality and is substantially crystalline. By “crystalline” is meant that the crosslinking agent contains at least some crystalline domains, and correspondingly may contain some amorphous domains. While not necessary, it is preferred that the epoxide reactive crosslinking agent have a melt viscosity less than that of the epoxy functional polymer (at the same temperature). As used herein, by “epoxide reactive crosslinking agent” is meant that the epoxide reactive crosslinking agent has at least two functional groups that are reactive with epoxide functionality.

Preferably, the epoxide reactive crosslinking agent is a carboxylic acid functional crosslinking agent, which typically contains from 4 to 20 carbon atoms. Examples of carboxylic acid functional crosslinking agents useful in the present invention include, but are not limited to, dodecanedioic acid, azelaic acid, adipic acid, 1,6-hexanedioic acid, succinic acid, pimelic acid, sebacic acid, maleic acid, citric acid, itaconic acid, aconitic acid and mixtures thereof.

Other suitable carboxylic acid functional crosslinking agents include those represented by the following general formula I, 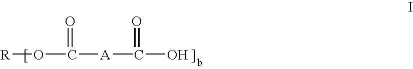
In general formula I, R is the residue of a polyol, A is a divalent linking group having from 1 to 10 carbon atoms, and b is an integer of from 2 to 10. Examples of polyols from which R of general formula I may be derived include, but are not limited to, ethylene glycol, di(ethylene glycol), trimethylolethane, trimethylolpropane, pentaerythritol, di-trimethylolpropane, di-pentaerythritol and mixtures thereof. Divalent linking groups from which A may be selected include, but are not limited to, methylene, ethylene, propylene, isopropylene, butylene, pentylene, hexylene, heptylene, octylene, nonylene, decylene, cyclohexylene, e.g., 1,2-cyclohexylene, substituted cyclohexylene, e.g., 4-methyl-1,2-cyclohexylene, phenylene, e.g., 1,2-phenylene, and substituted phenylene, e.g., 4-methyl-1,2-phenylene and 4-carboxylic acid-1,2-phenylene. The divalent linking group A is preferably aliphatic.

The crosslinking agent represented by general formula I is typically prepared from a polyol and a dibasic acid or cyclic anhydride. For example, trimethylol propane and hexahydro-4-methylphthalic anhydride are reacted together in a molar ratio of 1:3 respectively, to form a carboxylic acid functional crosslinking agent. This particular crosslinking agent can be described with reference to general formula I as follows, R is the residue of trimethylol propane, A is the divalent linking group 4-methyl-1,2-cyclohexene, and b is 3. Carboxylic acid functional crosslinking agents described herein with reference to general formula I are meant to include also any unreacted starting materials and/or co-products, e.g., oligomeric species, resulting from their preparation and contained therein.

One or more beta-hydroxyalkylamide crosslinking agents (i) may be present in curable powder coating compositions comprising carboxylic acid functional polymer as component (ii). The beta-hydroxyalkylamide crosslinking agent can be represented by the following general formula II: 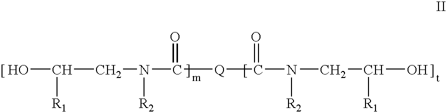
wherein R₁ is H or C₁-C₅ alkyl; R₂ is H, C₁-C₅ alkyl or 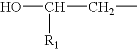
wherein R₁ is as described above, Q is a chemical bond or monovalent or polyvalent organic radical derived from saturated, unsaturated or aromatic hydrocarbon radicals including substituted hydrocarbon radicals containing from 2 to 20 carbon atoms, m equals 1 to 2, t equals 0 to 2, and m+t is at least 2. Preferably, Q is an alkylene radical —(CH₂)ₓ— where x is equal to 2 to 12, preferably 4 to 10; m is equal to 1 to 2, t is equal to 0 to 2, and m+t is at least 2, preferably greater than 2, usually within the range from greater than 2 up to and including 4. The beta-hydroxyalkylamide crosslinking agent represented by general formula II can be prepared by art recognized methods, as described herein, for example, U.S. Pat. No. 4,937,288 at column 7, lines 6 through 16.

Capped polyisocyanate crosslinking agents are also suitable for use as the crosslinking agent (i) in the curable powder film-forming composition of the present invention. By “capped polyisocyanate crosslinking agent” is meant at least one crosslinking agent having two or more capped isocyanate groups that can decap (or deblock) under cure conditions, e.g., at elevated temperature, to form free isocyanate groups and free capping groups. The free isocyanate groups formed by decapping of the crosslinking agent are preferably capable of reacting and forming substantially permanent covalent bonds with the hydroxy groups of hydroxy functional polymer.

It is desirable that the capping group of the capped polyisocyanate crosslinking agent not adversely affect the curable powder coating composition upon decapping from the isocyanate group; i.e., when it becomes a free capping group. For example, it is desirable that the free capping group neither become trapped in the cured film as gas bubbles nor excessively plasticize the cured film. Capping groups useful in the present invention preferably have the characteristics of being nonfugitive or capable of escaping substantially from the forming coating prior to its vitrification.

Suitable capping agents may be selected from: hydroxy functional compounds, e.g., ethylene glycol butyl ether, phenol and p-hydroxy methylbenzoate; 1H-azoles, e.g., 1H-1,2,4-triazole and 1H-2,5-dimethyl pyrazole; lactams, e.g., e-caprolactam and 2-pyrolidinone; ketoximes, e.g., 2-propanone oxime and 2-butanone oxime and those ketoximes described in U.S. Pat. No. 5,508,337 at column 7, lines 11 through 22, the disclosure of which is incorporated herein by reference. Other suitable capping groups include morpholine, 3-aminopropyl morpholine and N-hydroxy phthalimide.

The capped polyisocyanate crosslinking agent has two or more isocyanate groups and is preferably solid at room temperature. Examples of suitable polyisocyanates that may be used to prepare the capped polyisocyanate crosslinking agent include, monomeric diisocyanates, e.g., α,α′-xylylene diisocyanate, α,α,α′,α′-tetramethylxylylene diisocyanate and 1-isocyanato-3-isocyanatomethyl-3,5,5-trimethylcyclohexane (isophorone diisocyanate or IPDI), and dimers and trimers of monomeric diisocyanates containing isocyanurate, uretidino, biuret or allophanate linkages, e.g., the trimer of IPDI. Isocyanates that are useful in the present invention are described in further detail in U.S. Pat. No. 5,666,061 at column 3, line 4 through column 4, line 40, the disclosure of which is incorporated herein by reference. A particularly preferred polyisocyanate is a trimer of 1-isocyanato-3,3,5-trimethyl-5-isocyanatomethylcyclohexane.

The capped polyisocyanate crosslinking agent may also be selected from oligomeric capped polyisocyanate functional adducts. As used herein, by “oligomeric capped polyisocyanate functional adduct” is meant a material that is substantially free of polymeric chain extension. Oligomeric capped polyisocyanate functional adducts can be prepared by art-recognized methods from, for example, a compound containing three or more active hydrogen groups, e.g., trimethylolpropane (TMP), and an isocyanate monomer, e.g., 1-isocyanato-3,3,5-trimethyl-5-isocyanatomethylcyclohexane (IPDI), in a molar ratio of 1:3, respectively. In the case of TMP and IPDI, by employing art-recognized starved feed and/or dilute solution synthesis techniques, an oligomeric adduct having an average isocyanate functionality of 3 can be prepared (“TMP-3IPDI”). The three free isocyanate groups per TMP-3IPDI adduct are then capped with a capping group, e.g., 2-propanone oxime or e-caprolactam.

Polymers suitable for use as the functional group-containing polymer (ii) in the curable powder coating compositions of the present invention are solid at room temperature, typically having differential scanning calorimetry (DSC) derived glass transition midpoint values of from 30° C. to 80° C., e.g., from 35° C. to 50° C. These polymers also typically have number average molecular weights (Mₙ) of from 500 to 15,000.

The functional group-containing polymer (ii) typically is present in the curable powder film-forming composition of the present invention in an amount ranging from at least 5 percent by weight, preferably at least 20 percent by weight, based on the total weight of resin solids in the curable powder film-forming composition. The functional group-containing polymer (ii) also typically is present in the curable powder film-forming composition of the present invention in an amount less than 95 percent by weight, preferably less than 80 percent by weight, based on the total weight of resin solids in the curable powder coating composition. The amount of the functional group-containing polymer (ii) present in the film-forming composition of the present invention is dependent on the type of polymer used and can range between any combination of these values inclusive of the recited values.

Classes of epoxide functional polymers from which the functional group-containing polymer (ii) in the curable powder coating compositions of the present invention may be selected include, but are not limited to, epoxide functional vinyl polymers, e.g., epoxide functional (meth)acrylic polymers, epoxide functional polyethers, epoxide functional polyesters and combinations thereof. Epoxide functional vinyl polymers can be prepared by free radical polymerization methods that are known to those of ordinary skill in the art. Such known free radical polymerization methods typically make use of suitable initiators, which include organic peroxides and azo type compounds and chain transfer agents, such as alpha-methyl styrene dimer and tertiary dodecyl mercaptan.

Epoxide functional vinyl polymers are typically prepared by polymerizing one or more epoxide functional ethylenically unsaturated monomers, e.g., glycidyl methacrylate, with one or more ethylenically unsaturated monomers that are free of epoxide functionality, e.g., methyl (meth)acrylate, isobornyl (meth)acrylate, butyl (meth)acrylate and styrene. Examples of epoxide functional ethylenically unsaturated monomers that may be used in the preparation of epoxide functional vinyl polymers include, but are not limited to, glycidyl (meth)acrylate, 3,4-epoxycyclohexylmethyl (meth)acrylate, 2-(3,4-epoxycyclohexyl)ethyl (meth)acrylate and allyl glycidyl ether. Examples of ethylenically unsaturated monomers that are free of epoxide functionality include those described in the U.S. Pat. No. 5,407,707 at column 2, lines 17 through 56.

In a particular embodiment of the present invention, the epoxide functional vinyl polymer is prepared from a majority of (meth)acrylate monomers and is referred to herein as an “epoxide functional (meth)acrylic polymer”. The epoxide functional vinyl polymer typically has a number average molecular weight of from 500 to 5000, e.g., from 800 to 2500.

Epoxide functional polyethers can be prepared from a hydroxy functional monomer, e.g., a diol, and an epoxide functional monomer, and/or a monomer having both hydroxy and epoxide functionality. Suitable epoxide functional polyethers include, but are not limited to, those based on 4,4′-isopropylidenediphenol (Bisphenol A), a specific example of which is EPON® RESIN 2002 available commercially from Shell Chemicals.

Epoxide functional polyesters can be prepared by art-recognized methods, which typically include first preparing a hydroxy functional polyester that is then reacted with epichlorohydrin. Polyesters having hydroxy functionality may be prepared by art-recognized methods, which include reacting carboxylic acids (and/or esters thereof) having acid (or ester) functionalities of at least 2, and polyols having hydroxy functionalities of at least 2. As is known to those of ordinary skill in the art, the molar equivalents ratio of carboxylic acid groups to hydroxy groups of the reactants is selected such that the resulting polyester has hydroxy functionality and the desired molecular weight.

Examples of multifunctional carboxylic acids useful in preparing hydroxy functional polyesters are known to the skilled artisan and include, for example, phthalic acid, tetrahydrophthalic acid, hexahydrophthalic acid, isophthalic acid and terephthalic acid. Examples of polyols useful in preparing hydroxy functional polyesters are known to those skilled in the art and include, for example, glycerin, trimethylolpropane, ethylene glycol and 1,4-dimethylolcyclohexane.

Curable powder coating compositions comprising epoxide functional polymer and epoxide reactive crosslinking agent usually also include one or more cure catalysts for catalyzing the reaction between the reactive functional groups of the crosslinking agent and the epoxide groups of the polymer. Examples of cure catalysts for use with acid functional crosslinking agents include tertiary amines, e.g., methyl dicocoamine, and tin compounds, e.g., triphenyl tin hydroxide. Curing catalyst is typically present in the curable powder coating composition in an amount of less than 5 percent by weight, e.g., from 0.25 percent by weight to 2.0 percent by weight, based on total resin solids weight of the composition.

Curable powder coating compositions comprising epoxide functional polymer and epoxide reactive crosslinking agent typically have present therein epoxide functional polymer in an amount of from 60 percent to 95 percent by weight, based on total resin solids weight of the composition, e.g., from 70 percent to 85 percent by weight, based on total resin solids weight of the composition. The epoxide reactive crosslinking agent is typically present in the curable powder coating composition in an amount corresponding to the balance of these recited ranges (i.e., 5 to 40, and particularly 15 to 30 percent by weight). The equivalent ratio of epoxide equivalents in the epoxide functional polymer to the equivalents of reactive functional groups in the crosslinking agent is typically from 0.5:1 to 2:1, e.g., from 0.8:1 to 1.5:1. Curable powder coating compositions comprising epoxide functional polymer and carboxylic acid functional crosslinking agent are typically cured at a temperature of from 121° C. to 177° C. over a period of from 10 to 60 minutes.

Carboxylic acid functional vinyl polymers useful with beta-hydroxyalkylamide functional crosslinking agents can be prepared by free radical polymerization methods that are known to those of ordinary skill in the art, for example, free radical polymerization methods as described previously herein. The carboxylic acid functional vinyl polymer is typically prepared by polymerizing one or more carboxylic acid functional ethylenically unsaturated monomers, e.g., (meth)acrylic acid, with one or more ethylenically unsaturated monomers that are free of carboxylic acid functionality, e.g., methyl (meth)acrylate, isobornyl (meth)acrylate, butyl (meth)acrylate and styrene. Alternatively, the carboxylic acid functional vinyl polymer may be prepared by first preparing a hydroxy functional vinyl polymer that is then reacted with a cyclic anhydride, e.g., succinic anhydride. Carboxylic acid functional vinyl, e.g., (meth)acrylic, polymers useful in the present invention are described in further detail in U.S. Pat. No. 4,937,288, column 2, line 1 through column 4, line 17.

Polyesters having carboxylic acid functionality may be prepared by art-recognized methods, which include reacting carboxylic acids (and/or esters thereof) having acid (or ester) functionalities of at least 2, and polyols having hydroxy functionalities of at least 2. As is known to those of ordinary skill in the art, the molar equivalents ratio of carboxylic acid groups to hydroxy groups of the reactants is selected such that the resulting polyester has carboxylic acid functionality and the desired molecular weight. Carboxylic acid functional polyesters useful in the present invention are described in, for example, U.S. Pat. No. 4,937,288, column 4, line 18 through column 6, line 12.

Carboxylic acid functional polyurethanes may be prepared by reacting polyols and polyisocyanates so as to form a polyurethane polyol, which is then reacted with polycarboxylic acid or cyclic anhydride to introduce free carboxylic acid groups into the reaction product. Carboxylic acid functional polyurethanes that may be used in curable powder coating compositions comprising beta-hydroxyalkylamide crosslinking agent are described in further detail in U.S. Pat. No. 4,837,288, at column 6, lines 13 through 39.

Curable powder coating compositions comprising carboxylic acid functional polymer and beta-hydroxyalkylamide crosslinking agent typically have present therein carboxylic acid functional polymer in an amount of from 60 percent to 95 percent by weight, based on total resin solids weight of the composition, e.g., from 80 percent to 90 percent by weight, based on total resin solids weight of the composition. The beta-hydroxyakylamide crosslinking agent is typically present in the curable powder coating composition in an amount corresponding to the balance of these recited ranges (i.e., 5 to 40, and particularly 10 to 20 percent by weight).

To achieve a suitable level of cure, the equivalent ratio of hydroxy equivalents in the beta-hydroxyalkylamide crosslinking agent to carboxylic acid equivalents in the carboxylic acid functional polymer is preferably from 0.6:1 to 1.6:1, and more preferably from 0.8:1 to 1.3:1. Ratios outside the range of 0.6:1 to 1.6:1 are generally undesirable due to the resulting poor cure response associated therewith. Curable powder coating compositions comprising carboxylic acid functional polymer and beta-hydroxyalkylamide functional crosslinking agent are typically cured at a temperature of from 149° C. to 204° C. over a period of from 10 to 60 minutes, using suitable amine or tin catalysts as known to those skilled in the art.

Hydroxy functional polymers that can be used as component (ii) in combination with capped polyisocyanate functional crosslinking agents include, but are not limited to, hydroxy functional vinyl polymers, hydroxy functional polyesters, hydroxy functional polyurethanes and mixtures thereof.

Vinyl polymers having hydroxy functionality can be prepared by free radical polymerization methods that are known to those of ordinary skill in the art, for example as described in U.S. Pat. No. 5,508,337, column 3, line 15 through column 5, line 23. In an embodiment of the present invention, the hydroxy functional vinyl polymer is prepared from a majority of (meth)acrylate monomers and is referred to herein as a “hydroxy functional (meth)acrylic polymer.”

Hydroxy functional polyesters useful in curable powder coating compositions comprising capped isocyanate functional crosslinking agent can be prepared by art-recognized methods. Typically, diols and dicarboxylic acids or diesters of dicarboxylic acids are reacted in a proportion such that the molar equivalents of hydroxy groups is greater than that of carboxylic acid groups (or esters of carboxylic acid groups) with the concurrent removal of water or alcohols from the reaction medium. Hydroxy functional polyesters useful in the present invention are described in further detail in U.S. Pat. No. 5,508,337 at column 5, line 24 through column 6, line 30.

Hydroxy functional urethanes can be prepared by art-recognized methods, for example, as previously described herein using excess amounts of polyol. Hydroxy functional urethanes useful in the present invention are described in further detail in U.S. Pat. No. 5,510,444, at column 5, line 33 through column 7, line 61.

To catalyze the reaction between the isocyanate groups of the capped polyisocyanate crosslinking agent and the hydroxy groups of the hydroxy functional polymer, one or more catalysts are typically present in the powder coating composition in amounts of from, for example, 0.1 to 5 percent by weight, based on the total resin solids of the composition. Classes of useful catalysts include, metal compounds, in particular, organic tin compounds, e.g., tin(II) octanoate and dibutyltin(IV) dilaurate, and tertiary amines, e.g., diazabicyclo[2.2.2]octane. Examples of organic tin compounds and tertiary amines are described in U.S. Pat. No. 5,507,337 at column 7, lines 28 through 49, the disclosure of which is incorporated herein by reference.

Curable powder coating compositions comprising hydroxy functional polymer and capped isocyanate functional crosslinking agent, typically have present therein hydroxy functional polymer in an amount of from 55 percent to 95 percent by weight, based on total resin solids weight of the composition, e.g., from 75 percent to 90 percent by weight, based on total resin solids weight of the composition. The capped isocyanate functional crosslinking agent is typically present in the powder composition in an amount corresponding to the balance of these recited ranges (i.e., 5 to 45, and particularly 10 to 25 percent by weight).

The equivalent ratio of isocyanate equivalents in the capped isocyanate crosslinking agent to hydroxy equivalents in the hydroxy functional polymer is typically within the range of 1:3 to 3:1, e.g., 1:2 to 2:1. While equivalent ratios outside of this range can be employed, they are generally less desirable due to performance deficiencies in cured films obtained therefrom. Powder coating compositions comprising hydroxy functional polymer and capped isocyanate functional crosslinking agent are typically cured at a temperature of from 120° C. to 190° C. over a period of from 10 to 60 minutes.

The curable powder film-forming composition of the present invention further comprises (iii) sub-micron sized particles present in an amount at least sufficient to improve the flow and leveling of the composition when applied to a substrate and cured, as measured by longwave scanning, compared to a similar cured coating without the particles. The particles may typically be present in an amount less than 30 percent by volume, preferably less than 15 percent by volume, more preferably less than 10 percent by volume, based on the total volume of the film-forming composition. The particles typically have a mean particle size less than 100 nm, often less than 50 nm, more often less than 20 nm. The average particle size can be determined by visually examining an electron micrograph of a transmission electron microscopy (“TEM”) image, measuring the diameter of the particles in the image, and calculating the average particle size based on the magnification of the TEM image. One of ordinary skill in the art will understand how to prepare such a TEM image, and determine the particle size based on the magnification. The diameter of the particle refers to the smallest diameter sphere that will completely enclose the particle.

It will be recognized by one skilled in the art that mixtures of one or more particles having different average particle sizes can be incorporated into the compositions in accordance with the present invention to impart the desired properties and characteristics to the compositions. For example, particles of varying particle sizes can be used in the compositions according to the present invention.

In one embodiment, the particles (iii) further have an index of refraction (n) that is greater than or less than that of the mixture of crosslinking agent (i) and polymer (ii) by an amount less than Δnₘₐₓ, defined below.

The quantity Δnₘₐₓ, the maximum difference in refractive index between the particles (iii) and the mixture of crosslinking agent (i) and polymer (ii), is dependent on the size (diameter, d) in nm of the particles (iii) and is determined according to the equation:
Δnₘₐₓ=H/d²
where H is an allowable haze factor. For a film-forming composition that is substantially free from haze, H should be less than 200, preferably less than 133, more preferably less than 41. For example, if the size (d) of particles (iii) is 20 nm, Δnₘₐₓ is preferably less than 0.333, more preferably less than 0.103, while if the size (d) of particles (iii) is 75 nm, Δnₘₐₓ is preferably less than 0.024, more preferably less than 0.007.

Typically the refractive index of the particles ranges between 1.45 and 1.80, preferably between 1.50 and 1.55. The particles are also substantially colorless. Such optical properties allow for the use of the particles in film-forming compositions, particularly clear film-forming compositions, without affecting the gloss of transparency thereof. Therefore, the composition is particularly suitable for use in applications requiring excellent appearance properties, such as in automotive applications.

The particles are prepared such that they are substantially free of functional groups, such as hydroxyl groups, on the particle surface. The particles are also substantially free of any surface treatment. Such characteristics distinguish the particles used in the composition of the present invention from conventional particles such as fumed silica commonly used in the coatings industry. Conventional particles, which are usually surface treated and hare highly surface active due to the presence of functional groups on the surface thereof, tend to agglomerate during their preparation or upon addition to a composition.

The shape (or morphology) of the particles can vary depending upon the specific embodiment of the present invention and its intended application. For example, generally spherical morphologies can be used, as well as particles that are cubic, platy, or acicular (elongated or fibrous). In general, the particles are substantially spherical in shape.

In one embodiment, the particles (iii) may be a complex metal oxide comprising a homogeneous mixture, or solid state solution of two or more (up to x) metal oxides, labeled MO1, MO2, . . . , MOx, having an effective refractive index (n_{eff}) that is closely approximated as a volume average of the refractive indices of the component metal oxides, determined according to the equation:
n_{eff}=(C_{MO1}·n_{MO1}/ρ_{MO1})+(C_{MO2}·n_{MO2}/ρ_{MO2})+. . . +(C_{MOx}·n_{MOx}/ρ_{MOx})
where n_{MO1}, n_{MO2}, . . . , n_{MOx} are the respective refractive indices of the metal oxides, MO1, MO2, . . . , MOx; C_{MO1}, C_{MO2}, . . . , C_{MOx} are the weight fractions of the metal oxides, MO1, MO2, . . . , MOx; and ρ_{MO1}, ρ_{MO2}, . . . , ρ_{MOx}, are the respective densities of the metal oxides, MO1, MO2, . . . , MOx.

For example, amorphous silica has a refractive index of about 1.46 and a density of about 2.2, and alumina has a refractive index of about 1.76 and a density of about 4.0. A mixed metal oxide comprising 60 weight percent silica and 40 weight percent alumina would have an effective refractive index of approximately 1.54.

The metal oxides may be selected from at least one of aluminum oxide, zinc oxide, zirconium oxide and silicon dioxide. When the metal oxides are mixed; i.e., more than one type of metal oxide is used, they typically form a homogeneous mixture within the particle. The particles may further comprise one or more carbides such as silicon carbide; nitrides such as silicon nitride, aluminum nitride and boron nitride present at a total of up to 100 percent by weight, based on the total weight of the particles. The particles most often comprise 10 to 70 percent by weight aluminum oxide and 30 to 90 percent by weight silica.

The particles used in the film-forming composition of the invention may be prepared by reacting together the metal oxide precursors and any other ingredients in any of a variety of processes. The particles may be prepared by a process comprising: (a) introducing reactants into a reaction chamber; (b) rapidly heating the reactants by means of a plasma to a selected reaction temperature sufficient to yield a gaseous reaction product; (c) preferably passing the gaseous reaction product through a restrictive convergent-divergent nozzle to effect rapid cooling, or utilizing an alternative cooling method such as a cool surface or quenching gas, and (d) condensing the gaseous reaction product to yield ultrafine solid particles.

One process for preparing the particles (iii) is fully described in U.S. Pat. No. 5,749,937. The process comprises: (a) introducing a reactant stream (in the case of the particles used in the composition of the present invention, comprising the one or more metal oxides and silica) into one axial end of a reaction chamber; (b) rapidly heating the reactant stream by means of a plasma to a selected reaction temperature as the reactant stream flows axially through the reaction chamber, yielding a gaseous reaction product; (c) passing the gaseous reaction product through a restrictive convergent-divergent nozzle arranged coaxially within the end of the reaction chamber to rapidly cool the gaseous reaction product adiabatically and isentropically as the gaseous reaction product flows through the nozzle, retaining a desired end product within the flowing gaseous stream; and (d) subsequently cooling and slowing the velocity of the desired end product exiting from the nozzle, yielding ultrafine solid particles.

Suitable reactants to be used as part of the reactant stream include zinc oxide, aluminum oxide, zirconium dioxide, silicon dioxide, boron oxide or hydride, nitrogen and methane. The reactant stream may be introduced to the reaction chamber as a solid, liquid, or gas, but is usually introduced as solid.

Curable powder coating compositions of the present invention may optionally contain additives such as waxes to improve the slip properties of the cured coating, degassing additives such as benzoin, adjuvant resin to modify and optimize coating properties, catalysts, antioxidants and ultraviolet (UV) light absorbers. Examples of useful antioxidants and UV light absorbers include those available commercially from Ciba-Geigy under the trademarks IRGANOX and TINUVIN. These optional additives, when used, are typically present in amounts up to 20 percent by weight, based on the total weight of resin solids in the curable composition.

Curable powder coating compositions useful in the present invention are typically prepared by first dry blending the functional polymer, e.g., epoxide functional polymer, the crosslinking agent, the particles and additives, such as degassing agents, flow control agents and catalysts, in a blender, e.g., a Henshel blade blender. The blender is operated for a period of time sufficient to result in a homogenous dry blend of the materials charged thereto. The homogenous dry blend is then melt blended in an extruder, e.g., a twin screw co-rotating extruder, operated within a temperature range sufficient to melt but not gel the components. For example, when preparing curable powder coating compositions comprising epoxide functional (meth)acrylic polymer and carboxylic acid functional crosslinking agent, the extruder is typically operated within a temperature range of from 80° C. to 140° C., e.g., from 100° C. to 125° C.

Optionally, curable powder coating compositions of the present invention may be melt blended in two or more steps. For example, a first melt blend is prepared in the absence of cure catalyst. A second melt blend is prepared at a lower temperature, from a dry blend of the first melt blend and the cure catalyst. The melt blended curable powder coating composition is typically milled to an average particle size of from, for example, 15 to 30 microns.

Alternatively, the powder coating compositions of the present invention can be prepared by blending and extruding the ingredients as described above, but without the particles. The particles can be added as a post-additive to the formulation, by simply mixing the particles into the milled powder coating composition such as by mixing using a Henschel mixer.

In an embodiment of the present invention, the curable powder coating composition is slurried in a liquid medium such as water, which may be spray applied. Where the language “co-reactable solid, particulate mixture” is used in the specification and claims, the thermosetting composition can be in dry powder form or in the form of a slurry.

The compositions of the present invention can be applied to various substrates to which they adhere including wood, metals, glass, and plastic. The compositions are most often applied by spraying. The usual spray techniques and equipment for air spraying and electrostatic spraying and either manual or automatic methods can be used.

The coating composition generally may be applied to a substrate by itself as a transparent or pigmented monocoat, or as the pigmented base coat and/or transparent topcoat in a color-plus-clear composite coating as known to those skilled in the art.

When the curable film-forming composition is used as part of a color-plus-clear composite coating, a colored film-forming composition is applied to a substrate base coat, and a film of the base coat is formed on the substrate. Typically, the base coat thickness will be about 0.01 to 5 mils (0.254 to 127 microns), preferably 0.1 to 2 mils (2.54 to 50.8 microns) in thickness.

The film-forming composition of the base coat in the color-plus-clear system may be the composition of the present invention or any other compositions useful in coatings applications, particularly automotive applications. The film-forming composition of the base coat comprises a resinous binder and a pigment to act as the colorant. Particularly useful resinous binders are acrylic polymers, polyesters, including alkyds, and polyurethanes.

The base coat compositions may be any powder, solventborne or waterborne composition known in the art. Waterborne base coats in color-plus-clear compositions are disclosed in U.S. Pat. No. 4,403,003, and the resinous compositions used in preparing these base coats can be used in the practice of this invention. Also, waterborne polyurethanes such as those prepared in accordance with U.S. Pat. No. 4,147,679 can be used as the resinous binder in the base coat. Further, waterborne coatings such as those described in U.S. Pat. No. 5,071,904 can be used as the base coat.

The base coat contains pigments to give it color. Any of the pigments disclosed above for use in the curable film-forming composition of the present invention may be used, in similar amounts.

If desired, the base coat composition may contain additional materials well known in the art of formulated surface coatings. These would include surfactants, flow control agents, thixotropic agents, fillers, anti-gassing agents, organic cosolvents, catalysts, and other customary auxiliaries. These material can constitute up to 40 percent by weight of the total weight of the coating composition.

After application of the base coat to the substrate, a film is formed on the surface of the substrate by driving any solvent, i.e., organic solvent or water, out of the base coat film by heating or by an air drying period. Suitable drying conditions will depend on the particular base coat composition and on the ambient humidity with certain waterborne compositions, but in general a drying time of from about 1 to 5 minutes at a temperature of about 80-250° F. (20-121° C.) will be adequate to ensure that mixing of the two coats is minimized. More than one base coat and multiple topcoats may be applied to develop the optimum appearance. Usually between coats, the previously applied coat (if liquid) is flashed; that is, exposed to ambient conditions for about 0.5 to 10 minutes.

The clear topcoat composition is then applied to the base coat, typically by spray application. The thickness of the coating is usually from about 0.5-5 mils (12.7 to 127 microns), preferably 1.0-3 mils (25.4 to 76.2 microns).

The two coatings are then heated to conjointly cure both coating layers. In the curing operation, solvents are driven off, solid resin particles of powder compositions are melted, and the film-forming materials of the clear coat and the base coat are each crosslinked. The heating or curing operation is usually carried out at a temperature in the range of from 160-350° F. (71-177° C.) but if needed, lower or higher temperatures may be used as necessary to activate crosslinking mechanisms. Note that when the coating composition of the present invention is used as a monocoat, the same curing conditions are suitable.

As used herein, the term “cure” as used in connection with a composition, e.g., “a curable composition”, shall mean that any crosslinkable components of the composition are at least partially crosslinked. In certain embodiments of the present invention, the crosslink density of the crosslinkable components, i.e., the degree of crosslinking, ranges from 5% to 100% of complete crosslinking. In other embodiments, the crosslink density ranges from 35% to 85% of full crosslinking. In other embodiments, the crosslink density ranges from 50% to 85% of full crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen. This method determines the glass transition temperature and crosslink density of free films of coatings or polymers. These physical properties of a cured material are related to the structure of the crosslinked network.

According to this method, the length, width, and thickness of a sample to be analyzed are first measured, the sample is tightly mounted to the Polymer Laboratories MK III apparatus, and the dimensional measurements are entered into the apparatus. A thermal scan is run at a heating rate of 3° C./min, a frequency of 1 Hz, a strain of 120% and a static force of 0.01N, and sample measurements occur every two seconds. The mode of deformation, glass transition temperature, and crosslink density of the sample can be determined according to this method. Higher crosslink density values indicate a higher degree of crosslinking in the coating.

The compositions of the present invention exhibit improved flow and leveling properties upon application to a substrate, resulting in excellent appearance properties in the cured film. One such property is gloss. In certain embodiments, the cured composition or coating of the present invention has a 20° gloss (as measured using a 20° NOVO-GLOSS 20 statistical glossmeter, available from Gardner Instrument Company) of greater than 70, can be greater than 75, and is often greater than 80.

For the composition of the present invention, the leveling of a cured coating applied to a substrate is significantly better than a similar cured coating composition without the particles. Such measurement may be done using the Byk® wavescan, reported in longwave numbers.

The present invention will further be described by reference to the following examples. The following examples are merely illustrative of the invention are not intended to be limiting. Unless otherwise indicated, all parts are by weight.

### EXAMPLE 1

Epoxy-acid powder clear coat compositions identified as Samples 1 and 2 in Table I were prepared using the components and amounts (parts by weight) shown, and processed in the following manner. The components were blended in a Henschel Blender for 60 to 90 seconds. The mixtures were then extruded through a Werner & Pfleider co-rotating twin screw extruder at a 450 RPM screw speed and an extrudate temperature of 100° C. to 125° C. The extruded material was then ground to a mean particle size of 17 to 27 μm using an ACM 2 (Air Classifying Mill from Hosakowa Micron Powder Systems). The finished powders were electrostatically sprayed onto test panels and evaluated for appearance.

TABLE 1

| | Sample 1 | |
|---|---|---|
| Description | Comparative | Sample 2 |
| GMA Functional Acrylic¹ | 69.05 | 68.30 |
| DDDA² | 22.68 | 22.43 |
| Benzoin | 0.20 | 0.20 |
| Wax C Micropowder³ | 0.60 | 0.60 |
| Tinuvin 144⁴ | 2.00 | 2.00 |
| CGL-1545⁵ | 2.00 | 2.00 |
| HCA-1⁶ | 2.00 | 2.00 |
| ARMEEN M2C⁷ | 0.37 | 0.37 |
| Acrylic Flow Additive⁸ | 1.10 | 1.10 |
| D235 Aluminum Silicate | 0 | 1.00 |
| nanospheres⁹ | | |
| Total | 100.00 | 100.00 |

¹U.S. Pat. No. 6,277,917 Example B.
²Dodecanedioic acid.
³Wax C Micro Powder, a fatty acid amide (ethylene bis-stearoylamide), commercially available from Hoechst-Celanese.
⁴TINUVIN 144 (2-tert-butyl-2-(4-hydroxy-3,5-di-tert-butylbenzyl)[bis(methyl-2,2,6,6-tetramethyl-4-piperidinyl)]dipropionate), an ultraviolet light stabilizer available from Ciba-Geigy Corp.
⁵CGL-1545 (2-[4((2-Hydroxy-3-(2-ethylhexyloxy)propyl)-oxy]-2-hydroxyphenyl)-4,6-bis(2,4-dimethylphenyl)-1,3,5-triazine), an ultraviolet light stabilizer available from Ciba-Geigy Corp.
⁶HCA-1, an anti-yellowing agent (antioxidant) commercially available from Sanko Chemical Corp.
⁷Methyl dicocaoamine available from Akzo-Nobel Corp., used as a catalyst.
⁸U.S. Pat. No. 6,013,733.
⁹D235 Aluminum Silicate (Al₂O₃ 4SiO₂) nanospheres were made by Nanomaterials Research Corporation; the particles were spherical with an average particle size less than 100 nm. The material had a refractive index of 1.518.

Test panels of Samples 1 and 2 were prepared using cold rolled steel panels coated with PPG Industries, Inc. black electrocoat ED5051, fully cured (coated panels available from ACT Laboratories.) The powder coatings of Samples 1 and 2 were applied at 58 to 71 μm and cured for 30 minutes at 293° F. (145° C.). The panels were then were tested for appearance. Gloss, Haze, and Distinctness of Image (DOI) were measured using a Byk-Gardner 20° gloss/haze instrument. A Byk Wavescan was used to characterize the roughness, e.g., longwave, shortwave, and GM Tension values. Better visual appearance is generally observed when the gloss, DOI, and GM Tension values are higher while the haze, longwave, and shortwave values are lower. A few number difference in gloss, haze, or DOI is minimally noticeable by eye; whereas even 0.5 number difference in longwave and GM Tension is visually obvious. Table 2 illustrates appearance properties for test panels baked horizontally.

TABLE 2

| | Sample 1 | |
|---|---|---|
| Appearance | Comparative | Sample 2 |
| Film Thickness (μm) | 63 | 65 |
| 20° Gloss | 84 | 83 |
| Haze | 27 | 26 |
| DOI | 86 | 92 |
| Longwave | 3.5 | 1.4 |
| Shortwave | 12.6 | 10.3 |
| GM Tension | 16.9 | 18.8 |

The results of Table 2 demonstrate that the incorporation of nanoparticles provides enhanced appearance.

### Thin Film

It is desirable to apply lower coating film thickness if it is possible to maintain an acceptable appearance. Typically as the film build of an applied coating composition is decreased, however, the appearance of the resulting cured coating typically diminishes. With the addition of 1 wt. % nanoparticles to the composition as in Sample 2, however, it is possible to achieve good appearance at a much lower film thickness. The test panels in Table 3 were again baked horizontally.

TABLE 3

| | Sample 1 | |
|---|---|---|
| Appearance | Comparative | Sample 2 |
| Film Thickness (μm) | 51 | 53 |
| 20° Gloss | 85 | 83 |
| Haze | 26 | 26 |
| DOI | 88 | 92 |
| Longwave | 4.7 | 3.3 |
| Shortwave | 11.9 | 11.2 |
| GM Tension | 16.1 | 17.0 |

The results of Table 3 illustrate that at a low film thickness Sample 2 exhibits superior appearance to comparative Sample 1, which lacks any particles. In fact, Sample 2 at a film thickness of 53 μm has equal or better appearance to Sample 1 at a film thickness of 63 μm (Table 1).

### Thin Film Panels Baked Vertically

Typically, test panels are baked in a horizontal position. However, it is known that commercial work pieces often have both horizontal and vertical surfaces that must be coated and cured. It is also known that vertical surfaces tend to have worse appearance properties than horizontal surfaces. The test panels in Table 4 were baked vertically.

TABLE 4

| | Sample 1 | |
|---|---|---|
| Appearance | Comparative | Sample 2 |
| Film Thickness (μm) | 52 | 49 |
| 20° Gloss | 85 | 84 |
| Haze | 21 | 24 |
| DOI | 87 | 89 |
| Longwave | 9.3 | 7.5 |
| Shortwave | 10.1 | 11.1 |
| GM Tension | 13.9 | 14.6 |

The data in Table 4 demonstrates that even when baked vertically the appearance of Sample 2 is better than that of Sample 1, which does not contain particles.

### Coating System Panels

To simulate actual commercial coating systems, additional test panels were prepared. The test panels, pre-coated with a gray electrocoat commercially available from PPG Industries, Inc., as ED5000 were coated with a black primer/surfacer commercially available from Akzo Nobel Corporation and a black basecoat commercially available from BASF by spray application to a film thickness of 29.3 μm and 14.6 μm, respectively. The powder clearcoat compositions of Sample 1 and Sample 2 were then electrostatically applied to these basecoated panels. The test panels were cured horizontally. Results are shown in Table 5 below.

TABLE 5

| | Sample 1 | |
|---|---|---|
| Appearance | Comparative | Sample 2 |
| Film Thickness (μm) | 67 | 54 |
| 20° Gloss | 84 | 83 |
| Haze | 16 | 16 |
| DOI | 83 | 84 |
| Longwave | 4.9 | 3.9 |
| Shortwave | 18.6 | 20.3 |
| GM Tension | 16.2 | 16.9 |

The data in Table 5 demonstrates that over basecoated panels the appearance of Sample 2, which contains nanoparticles, is better than the comparative Sample 1 with a thicker clearcoat film.

### EXAMPLE 2

Epoxy-acid powder clear coat compositions identified as Samples 3 through 6 in Table 6 were prepared using the components and amounts (parts by weight) shown, and processed as in Example 1.

TABLE 6

| | Sample 3 | | Sample 5 | |
|---|---|---|---|---|
| Description | Comparative | Sample 4 | Comparative | Sample 6 |
| GMA Functional | 69.05 | 68.30 | 69.05 | 68.30 |
| Acrylic¹ | | | | |
| DDDA² | 22.68 | 22.43 | 22.68 | 22.43 |
| Benzoin | 0.20 | 0.20 | 0.20 | 0.20 |
| Wax C | 0.60 | 0.60 | 0.60 | 0.60 |
| Micropowder³ | | | | |
| Tinuvin 144⁴ | 2.00 | 2.00 | 2.00 | 2.00 |
| CGL-1545⁵ | 2.00 | 2.00 | 2.00 | 2.00 |
| HCA-1⁶ | 2.00 | 2.00 | 2.00 | 2.00 |
| ARMEEN M2C⁷ | 0.37 | 0.37 | 0.37 | 0.37 |
| Modaflow⁸ | 1.10 | 1.10 | | |
| Flow Additive⁹ | | | 1.10 | 1.10 |
| D235 Aluminum | | 1.00 | | 1.00 |
| Silicate | | | | |
| nanospheres¹⁰ | | | | |
| Total | 100.00 | 100.00 | 100.00 | 100.00 |

¹U.S. Pat. No. 6,277,917 Example B.
²Dodecanedioic acid.
³Wax C Micro Powder, a fatty acid amide (ethylene bis-stearoylamide), commercially available from Hoechst-Celanese.
⁴TINUVIN 144 (2-tert-butyl-2-(4-hydroxy-3,5-di-tert-butylbenzyl)[bis(methyl-2,2,6,6-tetramethyl-4-piperidinyl)]dipropionate), an ultraviolet light stabilizer available from Ciba-Geigy Corp.
⁵CGL-1545 (2-[4((2-Hydroxy-3-(2-ethylhexyloxy)propyl)-oxy]-2-hydroxyphenyl)-4,6-bis(2,4-dimethylphenyl)-1,3,5-triazine), an ultraviolet light stabilizer available from Ciba-Geigy Corp.
⁶HCA-1, an anti-yellowing agent (antioxidant) commercially available from Sanko Chemical Corp.
⁷Methyl dicocaoamine available from Akzo-Nobel Corp., used as a catalyst.
⁸Modaflow, an acrylic copolymer flow additive anti-crater additive commercially available from Solutia, Inc.
⁹U.S. Pat. No. 6,197,883 Example B.
¹⁰D235 Aluminum Silicate (Al₂O₃ 4SiO₂) nanospheres were made by Nanomaterials Research Corporation; the particles were spherical with an average particle size less than 100 nm. The material had a refractive index of 1.518.

The effect of the nanoparticles on appearance was studied as a function of flow additive type. Test panels were again prepared by electrostatically spraying the clearcoat at two film thicknesses over cold rolled steel panels coated with PPG Industries, Inc. black electrocoat ED5051 (coated panels from ACT Laboratories) and baked horizontally.

TABLE 7

| | Sample 3 | | Sample 5 | |
|---|---|---|---|---|
| Appearance | Comparative | Sample 4 | Comparative | Sample 6 |
| Film Thickness | 63 | 68 | 63 | 64 |
| (μm) | | | | |
| 20° Gloss | 68 | 77 | 81 | 82 |
| Haze | 69 | 33 | 29 | 23 |
| DOI | 48 | 93 | 94 | 94 |
| Longwave | 33.5 | 1.6 | 1.7 | 1.6 |
| Shortwave | 45.2 | 9.9 | 10.8 | 11.9 |
| GM Tension | 10.9 | 18.5 | 18.5 | 18.6 |

TABLE 8

| | Sample 3 | | Sample 5 | |
|---|---|---|---|---|
| Appearance | Comparative | Sample 4 | Comparative | Sample 6 |
| Film Thickness | 54 | 57 | 54 | 53 |
| (μm) | | | | |
| 20° Gloss | 68 | 77 | 82 | 82 |
| Haze | 78 | 30 | 23 | 23 |
| DOI | 43 | 90 | 91 | 93 |
| Longwave | 38.9 | 1.9 | 3.4 | 2.2 |
| Shortwave | 51.3 | 11.4 | 15.0 | 12.9 |
| GM Tension | 10.1 | 18.2 | 17.1 | 18.0 |

At both of the film thickness reported in Tables 7 and 8, the addition of 1 wt. % nanoparticles resulted in an improvement in appearance. This positive effect is readily seen when comparing Sample 3 and Sample 4.

Those skilled in the art will recognize that changes may be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

We claim:

1. A curable powder film-forming composition comprising (i) 5 to 95 percent by weight based on the total weight of the film-forming composition of a crosslinking agent; (ii) 5 to 95 percent by weight based on the total weight of the film-forming composition of a polymer containing a plurality of functional groups reactive with the crosslinking agent; and (iii) particles having a mean particle size less than 100 nm, wherein the particles are substantially free of hydroxyl functional groups on the particle surface, said particles present in an amount at least sufficient to improve the flow and leveling of the composition when applied to a substrate and cured, as measured by longwave scanning, compared to a similar cured coating without the particles, and wherein the particles comprise 10 to 70 percent by weight, based on the total weight of the particles, aluminum oxide and 30 to 90 percent by weight, based on the total weight of the particles, silica.

2. The film-forming composition of claim 1 wherein the particles are present in the film-forming composition in amounts less than 30 percent by volume, based on the total volume of the film-forming composition.

3. The film-forming composition of claim 2 wherein the particles are present in the film-forming composition in amounts less than 15 percent by volume, based on the total volume of the film-forming composition.

4. The film-forming composition of claim 1 wherein the particles (iii) have an index of refraction (n) that is greater than or less than that of the mixture of crosslinking agent (i) and polymer (ii) by an amount less than Δnₘₐₓ, where Δnₘₐₓ is determined by the equation:
Δn_{mzd}=H/d²
wherein H is an allowable haze factor and is less than 200, and d is the mean particle size of the particles (iii) in nanometers.

5. The film-forming composition of claim 4 wherein H is less than 133.

6. The film-forming composition of claim 5 wherein H is less than 41.

7. The film-forming composition of claim 1 wherein the particles have a mean particle size less than 50 nm.

8. The film-forming composition of claim 7 wherein the particles have a mean particle size less than 20 nm.

9. The film-forming composition of claim 1 wherein the particles are prepared by a process comparing: (a) introducing reactants into a reaction chamber; (b) rapidly heating the reactants by means of a plasma to a selected reaction temperature sufficient to yield a gaseous reaction product; (c) rapidly cooling the gaseous reaction product by passing the gaseous reaction product through a restrictive convergent-divergent nozzle or contacting the gaseous reaction product with a cool surface or quenching gas; and (d) condensing the gaseous reaction product to yield ultrafine solid particles.

10. The film-forming composition of claim 1 wherein the particles are prepared by a process comprising: (a) introducing a reactant stream into one axial end of a reaction chamber; (b) rapidly heating the reactant stream by means of a plasma to a selected reaction temperature as the reactant stream flows axially through the reaction chamber, yielding a gaseous reaction product; (c) passing the gaseous reaction product through a restrictive convergent-divergent nozzle arranged coaxially within the end of the reaction chamber to rapidly cool the gaseous reaction product adiabatically and isentropically as the gaseous reaction product flows through the nozzle, retaining a desired end product within the flowing gaseous stream; and (d) subsequently cooling and slowing the velocity of the desired end product exiting from the nozzle, yielding ultrafine solid particles.

11. A multi-component composite coating composition comprising a pigmented film-forming composition serving as a base coat and a clear film-forming composition serving as a transparent topcoat over the base coat wherein the transparent topcoat is a curable film-forming composition comprising (i) 10 to 90 percent by weight based on the total weight of resin solids in the clear film-forming composition of a crosslinking agent; (ii) 10 to 90 percent by weight based on the total weight of resin solids in the clear film-forming composition of a polymer containing a plurality of functional groups reactive with the crosslinking agent; and (iii) particles having a mean particle size less than 100 nm wherein the particles are substantially free of hydroxyl functional groups on the particle surface, said particles present in an amount at least sufficient to improve the flow and leveling of the clear film-forming composition when applied to a substrate and cured, as measured by longwave scanning, compared to a similar cured coating without the particles, and wherein the particles comprise 10 to 70 percent by weight, based on the total weight of the particles, aluminum oxide and 30 to 90 percent by weight, based on the total weight of the particles, silica.

12. The multi-component composite coating composition of claim 11 wherein the particles are present in the clear film-forming composition in amounts less than 30 percent by volume, based on the total volume of the clear film-forming composition.

13. The multi-component composite coating composition of claim 12 wherein the particles are present in the clear film-forming composition in amounts less than 15 percent by volume, based on the total volume of the clear film-forming composition.

14. The multi-component composite coating composition of claim 11 wherein the particles (iii) have an index of refraction (n) that is greater than or less than that of the mixture of crosslinking agent (i) and polymer (ii) by an amount less than Δnₘₐₓ,wherein Δnₘₐₓ is determined by the equation:
Δnₘₐₓ=H/d²
wherein H is an allowable haze factor and is less than 200, and d is the mean particle size of the particles (iii) in nanometers.

15. The multi-component composite coating composition of claim 14 wherein H is less than 133.

16. The multi-component composite coating composition of claim 15 wherein H is less than 41.

17. The multi-component composite coating composition of claim 11 wherein the particles have a mean particle size less than 50 nm.

18. The multi-component composite coating composition of claim 17 wherein the particles have a mean particle size less than 20 nm.

19. The multi-component composite coating composition of claim 11 wherein the particles are prepared by a process comprising: (a) introducing reactants into a reaction chamber; (b) rapidly heating the reactants by means of a plasma to a selected reaction temperature sufficient to yield a gaseous reaction product; (c) rapidly cooling the gaseous reaction product by passing the gaseous reaction product through a restrictive convergent-divergent nozzle or contacting the gaseous reaction product with a cool surface or quenching gas; and (d) condensing the gaseous reaction product to yield ultrafine solid particles.

20. The multi-component composite coating composition of claim 11 wherein the particles are prepared by a process comprising: (a) introducing a reactant stream into one axial end of a reaction chamber; (b) rapidly heating the reactant stream by means of a plasma to a selected reaction temperature as the reactant stream flows axially through the reaction chamber, yielding a gaseous reaction product; (c) passing the gaseous reaction product through a restrictive convergent-divergent nozzle arranged coaxially within the end of the reaction chamber to rapidly cool the gaseous reaction product adiabatically and isentropically as the gaseous reaction product flows through the nozzle, retaining a desired end product within the flowing gaseous stream; and (d) subsequently cooling and slowing the velocity of the desired end product exiting from the nozzle, yielding ultrafine solid particles.
